(19) United States
(12) Patent Application Publication
(10) Pub. No.: US 2011/0292214 A1
(43) Pub. Date: Dec. 1, 2011

(54) VIRTUAL GUARD GATE FOR A GATED COMMUNITY AND METHOD THEREFOR

(76) Inventor: Morgan Plaster, Las Vegas, NV (US)

(21) Appl. No.: 12/787,731

(22) Filed: May 26, 2010

(51) Int. Cl. H04N 7/18; G05B 23/02; E04H 17/20

(52) U.S. Cl. 348/159; 256/65.02; 340/3.1; 348/E07.085

(57) ABSTRACT

A modular fence has at least one post member having a hollow interior section. At least one rail having a hollow interior section is provided. The rail is coupled to the post so the hollow interior section of the post member is in communication with the hollow interior section of the rail. A holding device may be formed on a bottom section of the post member to position the modular fence in an upright position. A plurality of openings is formed in the post member and the rail. Wiring is positioned in the interior section of the post and the interior section of the rail. Connectors are attached to the wiring. Security equipment is attached to the wiring via the connectors, wherein the security equipment is attached to at least one of the post member or rail through one of the plurality of openings.

### FIELD OF THE INVENTION

The present invention relates to security systems, and more specifically, to a system for automating the security of a gated community through the use of a sophisticated array of cameras and photoelectric beams combined with an automated entrance gate, all of which are monitored by a third party monitoring company located off site.

### BACKGROUND OF THE INVENTION

A more secure neighborhood has proven to be a commodity which many people desire. Because of this, many people like to live in gated communities. However, many gated communities have unsupervised entrances. This allows many unauthorized vehicles to enter the gated community.

To help ensure security, it is typically necessary to employ several security agents and place them at one or more guard stations on the property. This is an ongoing and continuing expense, greatly adding to the cost of running and maintaining the security system.

Therefore, it would be beneficial to provide a virtual guard gate for a gated community and method therefor. The device and method should provide an automated system for allowing access for authorized users and vehicles while denying access to unrecognized or unauthorized users and vehicles.

### SUMMARY OF THE INVENTION

In accordance with one embodiment, a virtual guard gate for a gated community is disclosed. The virtual guard gate for a gated community has at least one camera positioned proximate an entrance gate of the gated community. A monitoring station monitor is provided for displaying images captured by the at least one camera located in an off site monitoring station. Receivers are located in a plurality of homes of the gated community for receiving the images captured by the at least one camera. An access device is located in the monitoring station and in each house within the gated community. The access device is used for opening the entrance gate when the images have been verified by one of an individual in the monitoring station or in one of the homes.

A modular fence has at least one post member having a hollow interior section. At least one rail having a hollow interior section is provided. The rail is coupled to the post so the hollow interior section of the post member is in communication with the hollow interior section of the rail. A holding device may be formed on a bottom section of the post member to position the modular fence in an upright position. A plurality of openings is formed in the post member and the rail. Wiring is positioned in the interior section of the post and the interior section of the rail. Connectors are attached to the wiring. Security equipment is attached to the wiring via the connectors, wherein the security equipment is attached to at least one of the post member or rail through one of the plurality of openings

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of a vehicle proximate the entrance gate;

FIG. 2 is an elevated perspective view of the entrance gate following erection of the stopping device;

FIG. 3 is an elevated perspective view of the entrance gate demonstrating the line of sight of the various cameras and also demonstrating the photoelectric entrance beam used in conjunction with the stopping device;

FIG. 4 is an elevated perspective view of the entrance gate demonstrating the line of sight of various cameras;

FIG. 5 is an elevated perspective view of the gated community with the entrance gate of the gated community in the foreground, and with a blow-up view of the monitoring cameras positioned on the fence of the gated community;

FIG. 6 demonstrates communication of the cameras with a server, communication of the server with a home within the community, communication of the server with the monitoring station, and communication of the server with the list of authorized vehicles and individuals and the list of individuals and vehicles within the gated community;

FIG. 7 is a perspective view of one embodiment of a modular fence section to be used in the virtual guard gate of the present invention;

FIG. 8 is a top view of a cover section to be used in the modular fence section of FIG. 7; and

FIG. 9 is a perspective view showing a fully assembly modular fence unit.

FIG. 10 is a simplified functional block diagram of the control panel used in the present invention.

### DETAILED DESCRIPTION OF THE PREFERRED EMBODIMENTS

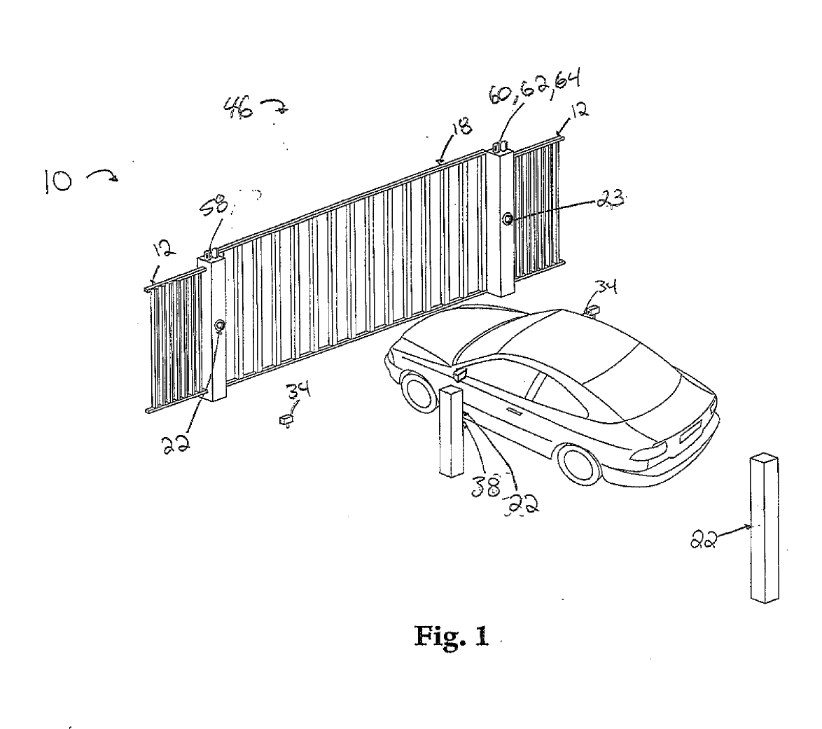

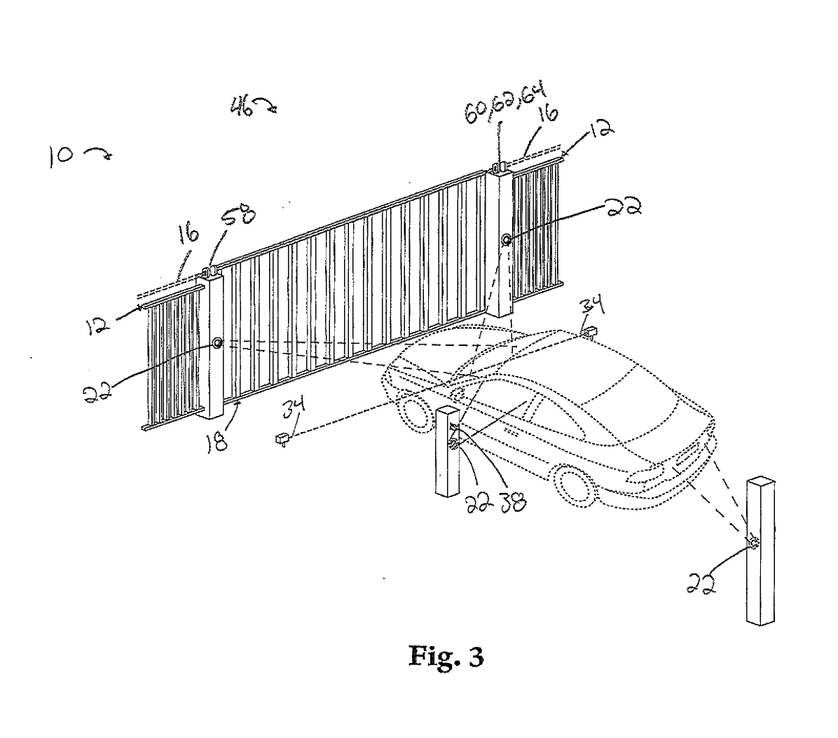

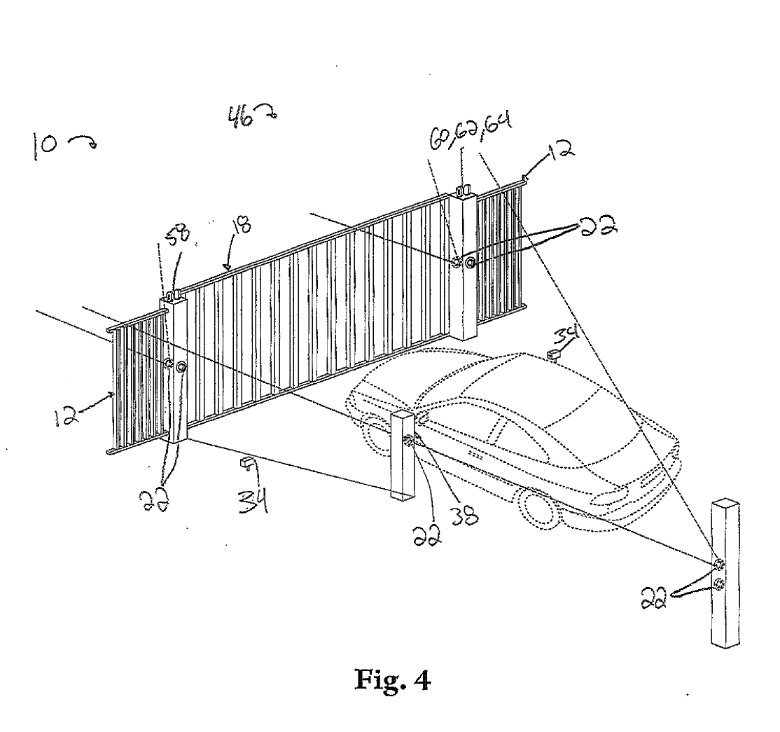

Referring to FIGS. 1-5, a virtual guard gate for a gated community 10 is shown. The virtual guard gate for a gated community 10 is used in combination with a fence 12 which is coupled to an entrance gate 18. In the preferred embodiment, the entrance gate 18 also acts as an exit gate, although it should be clear that substantial benefit could be derived from an alternative embodiment of the present invention in which a separate exit gate exists. The virtual guard gate for a gated community 10 may be employed in an existing gated community having unmanned entrance gates 18 or it may be used to replace the security agents currently being used at manned entrance gate of existing gated communities. Alternatively, the virtual guard gate for a gated community 10 may be instead in new gated communities being constructed.

The virtual guard gate for a gated community 10 has at least one camera 22 capable of recording the license plate of a vehicle or the facial features of an individual seeking entrance into the community located in close proximity to the entrance gate 18. In general, multiple cameras 22 are used so that both the license plate and facial features of the individuals seeking access are captured. Cameras 22 may also be positioned near the entrance gate 18 to monitor the entrance gate 18 to capture images of individuals who may be vandalizing the entrance gate 18, unauthorized individuals trying to climb over or get through the entrance gate 18 when closed, and the like. Similarly, additional cameras 22 may be used to record the license plate of a vehicle and the facial features of an individual exiting the gated community 46.

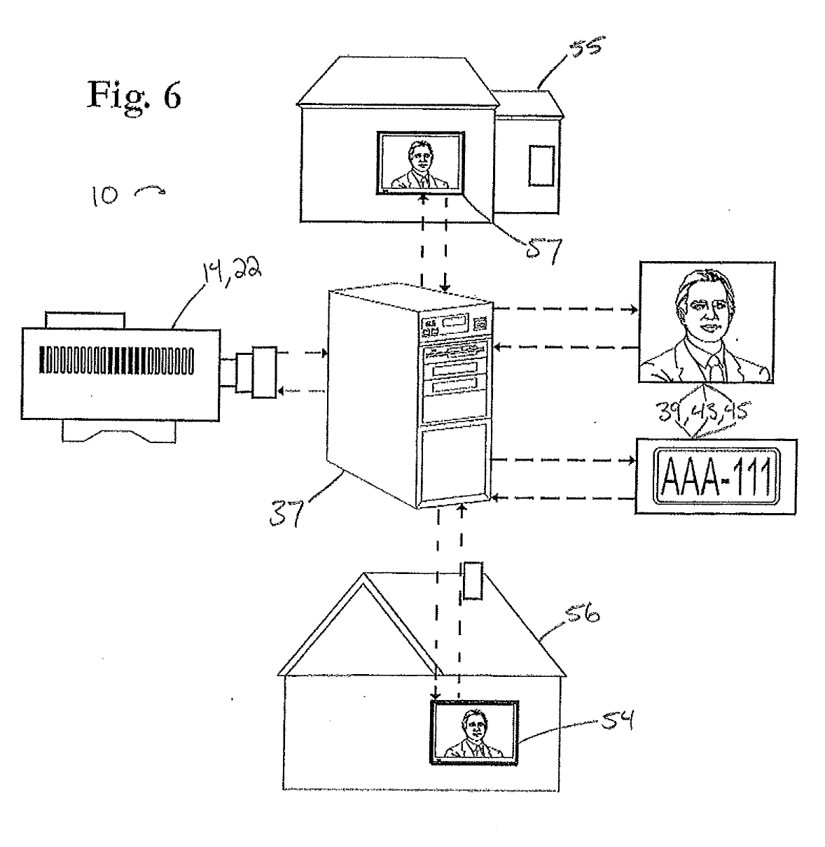

The cameras 22 are coupled to a server 37 (shown in FIG. 6). The cameras 22 transmit the captured images to the server 37. The server 37 analyzes the captured images and is capable of recognizing faces of individuals in the vehicle and characters on a license plate of the vehicle to determine whether the vehicle or individual has previously been entered into the server 37 and are authorized for entry into the gated community 46.

Referring to the FIG. 6, the images captured by the cameras 22 are then sent to the server 37 and compared to a database 39 of authorized individuals and vehicles. If the individual or vehicle is found to be authorized by the database 39, then the entry gate 18 is opened. Furthermore, the data representing the authorized individual or vehicle is stored in the server 37 on a database 43 of individuals and vehicles within the gated community 46. Similarly, the camera 22 which captures the images of the facial features of individuals and license plates of vehicles exiting the gated community 46 sends the information to the server 37, which then removes those individuals and vehicles from the list 43 of individuals and vehicles within the gated community 46. Thus, the server 37 will store information related to the individuals and the vehicles within the gated community 46.

The virtual guard gate for a gated community 10 may have a tag reader 23 located near the entrance gate 18. In accordance with one embodiment, the tag reader 23 is an RFID tag reader. The tag reader 23 will monitor for an identification tag which may be placed on the vehicle of people living in the gated community 46. The identification tag will only be given to authorized individuals gated community 46. If the tag reader senses an identification tag when a vehicle approaches the entrance gate 18, the entrance gate 18 automatically open.

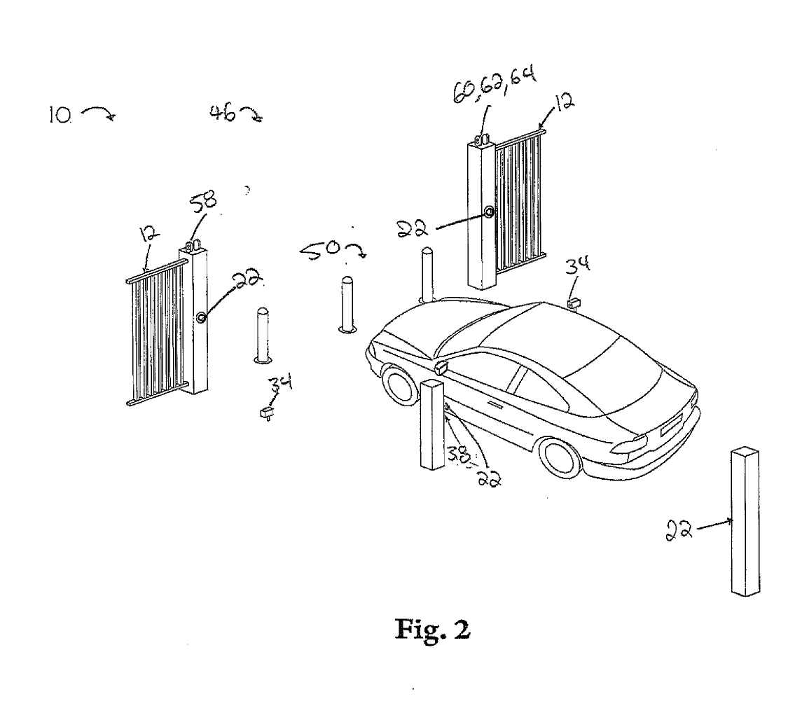

In close proximity to the entrance gate 18 is a photoelectric entrance beam 34. The photoelectric entrance beam is used for determining when the rearmost portion of an authorized vehicle has passed beyond a stopping device 50 (shown in FIG. 2). Once the photoelectric entrance beam 34 determines that the rearmost portion of an authorized vehicle has passed beyond a stopping device 50, a signal is sent to the stopping device 50 which raises the stopping device 50 to ensure that no vehicle enters behind the authorized vehicle without having undergone the authorization process. In the preferred embodiment, the stopping device 50 is a vertical stop barrier, but it should be clear that substantial benefit could be derived from an alternative embodiment of the present invention in which the stopping device 50 is a severe tire damage device. The stopping device 50 remains up until the entrance gate 18 closes, at which point the stopping device 50 lowers.

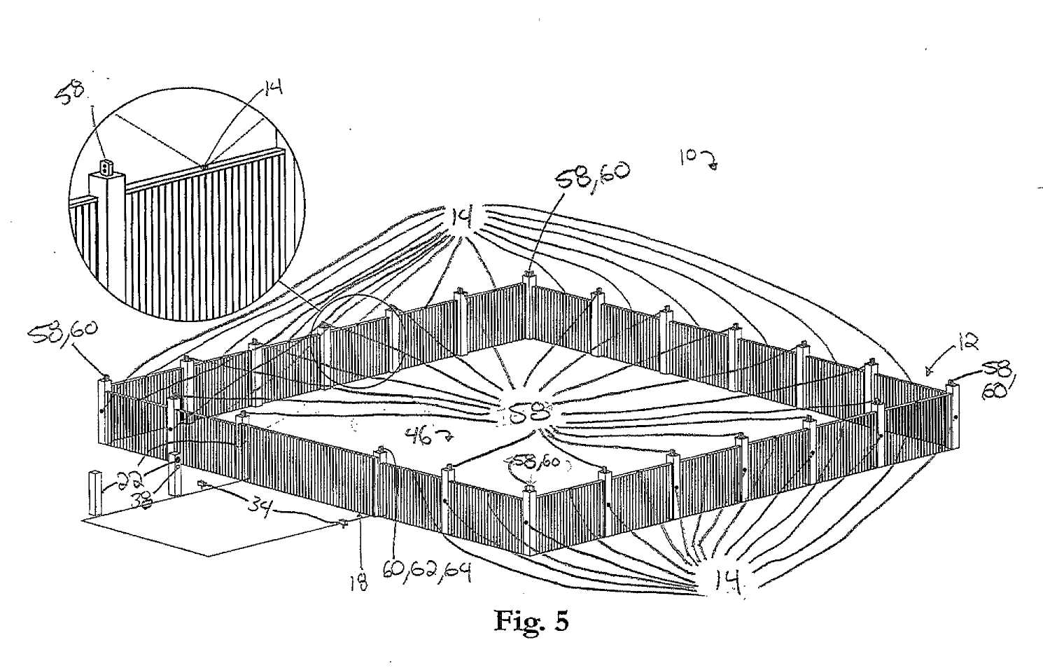

Referring to FIG. 5, positioned about the fence 12 is a plurality of monitoring cameras 14 and at least one photoelectric beam 16. The photoelectric beam 16 is directed around the perimeter of the fence 12. The monitoring cameras 14 and at least one photoelectric beam 16 are used to prevent unauthorized individuals from climbing over the fence 12 around the gated community 46. In the preferred embodiment, the monitoring cameras 14 are directed upwardly as to not contain any of the structures contained within the gated community 46 so as to eliminate privacy concerns. However, it should be clear that substantial benefit could be derived from an alternative embodiment of the present invention in which the monitoring cameras 14 are differently positioned. In general, a plurality of photoelectric beams 16 is used wherein the photoelectric beams 16 run in a horizontal plane on top of one another. The photoelectric beams 16 run parallel to, and on top of, the fence 12, and have a sufficient distance between them to allow the passage of a small animal, such as a cat or a bird, over the fence 12 of the gated community 46 while breaking only one of the photoelectric beams 16. This prevents false triggering of the virtual guard gate for a gated community 10. If multiple photoelectric beams 16 are broken, the virtual guard gate for a gated community 10 activates at least one monitoring camera 14 to capture images of the area where the photoelectric beams 16 were broken while putting the virtual guard gate for a gated community 10 in an alarm mode. In the preferred embodiment, any facial images captured by the monitoring cameras 14 are transmitted to the server 37 for analysis so that the server 37 may possibly identify the unauthorized individual.

In a preferred embodiment of the present invention, the photoelectric beams 16 originate from a single generating source 62 and are directed around the fence 12 and entrance gate of the gated community 46 using a plurality of partially transparent yet partially reflective mirrors 58 and reflective mirrors 60.

The following describes a three sided perimeter having three sections, although it should be clear that substantial benefit could be derived from an alternative embodiment of the present invention in which additional or fewer sides and/or sections exist. In the same area of the generating source 62 is a detecting source 64 capable of detecting varying beam intensity. The generating source 62 projects the photoelectric beams 16 toward a first partially transparent yet partially reflective mirror 58a. In the preferred embodiment, the partially transparent yet partially reflective mirrors 58 ideally have a 1 to 1 transmissitivity to reflectivity ratio on their leading edge, and a maximum transmissitivity and minimum reflectivity on their trailing edge, although it should be clear that substantial benefit could be derived from an alternative embodiment of the present invention in which the partially transparent yet partially reflective mirrors 58 have different properties. The partially transparent yet partially reflective mirrors 58 are each coupled to a reflective mirror 60 for redirection of the photoelectric beams 16, the reflective mirrors 60 ideally having a maximum reflectivity. The first reflective mirror 60a redirects the transmitted portion 16a of the photoelectric beams 16 passing through the first partially transparent yet partially reflective mirror 58a toward the second partially transparent yet partially reflective mirror 58b. Accordingly, a reflected portion 16b of the photoelectric beams 16 is returned from the first partially transparent yet partially reflective mirror 58a to the detecting source 64. The transmitted portion 16a travels toward the second partially transparent yet partially reflective mirror 58b. Similarly, the transmitted portion 16a has an additional transmitted portion 16c as well as a reflected portion 16d that is returned back to the detecting source 64 via the first reflective mirror 60a and through the first partially transparent yet partially reflective mirror 58a. Accordingly, the intensity perceived by the detecting source 64 is a combination of the reflected portion 16d and the reflected portion 16b. The additional transmitted portion 16c is then redirected by a second reflective mirror 60b toward a terminal reflective mirror 60c. The additional transmitted portion then travels back toward the detecting source 64 via the second reflective mirror 60b, through the second partially transparent yet partially reflective mirror 58b, being redirected by the first reflective mirror 60a, and passing through the first partially transparent yet partially reflective mirror 58a, resulting in the intensity perceived by the detecting source 64 being the combination of the additional transmitted portion 16c with the combined intensity of 16b and 16d.

This causes the intensity perceived by the detecting source 64 to be of a different level for each scenario involving a different section in which the photoelectric beams 16 are interrupted. If the photoelectric beams 16 are interrupted between the generating source 62 and the first partially transparent yet partially reflective mirror 58a, no beam intensity is detected. If the photoelectric beams 16 are interrupted between the first partially transparent yet partially reflective mirror 58a and the second partially transparent yet partially reflective mirror 58b, only 16b is detected. If the plurality of photoelectric beams 16 are interrupted between the second partially transparent yet partially reflective mirror 58b and terminal reflective mirror 60c, 16b plus 16d is detected. And if the plurality of photoelectric beams 16 is uninterrupted, then 16b plus 16d plus 16c is detected. This allows the virtual guard gate for a gated community 10 to use a common area for generating and detecting the plurality of photoelectric beams 16 while still being able to determine which section of the fence 12 has been breached. It should be noted that different embodiments may create additional sections through the use of additional partially transparent yet partially reflective mirrors 58 and reflective mirrors 60.

Referring to FIGS. 1-5, in proximity to the entrance gate 18 is a directory device 38 which contains a list of each family name of each home 56 (shown in FIG. 6) within the gated community 46, and enables an individual seeking authorization to communicate with an individual on the list 45 or the monitoring station 55 (shown in FIG. 6). Once an individual is selected from the list 45, the individual is alerted via a receiver 54 (shown in FIG. 6) within their home (shown in FIG. 6) that an unauthorized individual is requesting access. The individual is also able to view images of the entrance gate 18, and therefore the individual requesting authorization, via the receiver 54. The individual from whom access authorization is requested may then open the entrance gate 18 using an access device.

Referring to FIG. 6, a flow diagram relating to the information and data exchanged between the different entities and objects that make up the invention is shown. The various cameras 14 and 22 are represented by the image of a single camera, which is in constant communication with the server 37. The server 37 is in constant communication with, and is capable of manipulating, the list 39 of authorized individuals and license plates, the list 43 of individuals and vehicles within the gated community 46, and the list 45 of each family name of each home within the gated community 46.

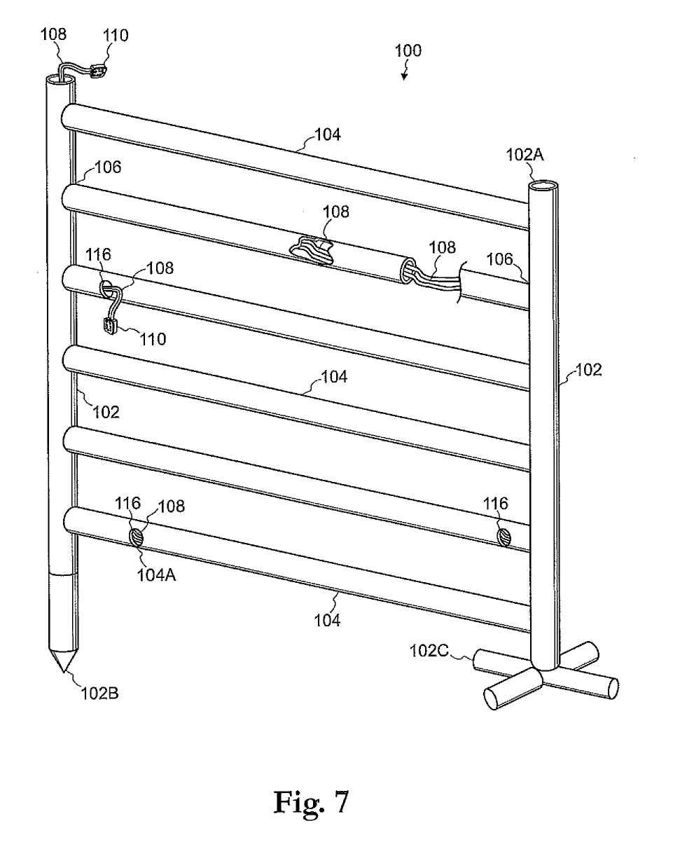

Referring to FIGS. 7-10, one embodiment of the fence 12 is shown. In this embodiment, the fence 12 is a modular fence 12A comprising a plurality of fence sections 100. The modular fence 12A may be used in a wide variety of applications, including for the virtual guard gate for a gated community 10 as discussed above. Alternatively, the modular fence 12A may be used to enclose an area or objects (i.e. construction equipment, etc) for security. Each of the fence sections 100 is designed to easily connect to another fence section 100 in order to form the modular fence 12A.

Each of the fence sections 100 may be made out of different material. In accordance with one embodiment, the fence section 100 is made from an extruded plastic material such as polyvinyl chloride or an extruded metal such as aluminum. It will be appreciated that other types of manufacturing techniques in addition to extrusion may be used and that the modular fencing system may also be made from other types of materials.

Each fence section 100 may include one or more extruded posts 102. While the present embodiment shows two posts 102, it is to be understood that each fence section 100 may have only one post 102. In this embodiment, the end of the fence section 100 not having a post 102 is attached to another end of an adjoin fence section 100 having a post 102.

Attached to the post 102 will be a plurality of fence rails 104. In accordance with one embodiment, each post 102 may have a plurality of spaced openings 106 along its length which are operable to receive a rail 104. In general, a pair of openings 106 may be located in opposing post 102 at selected locations along the length of the post 102. Accordingly, paired openings 106 on the opposite sides of the posts 102 may be horizontally aligned, which horizontally aligns the rails 104 of the fence section 100.

For each fence section 100, one or more of the post 102 may have a hollow interior 102A. One or more fence rails 104 may further have a hollow interior 104A. The hollow interior 102A and 104A may allow the fence section 100 to run wiring 108 through the fence section 100. In accordance with one embodiment, the fence section 100 may be pre-wired for easy installation. The wiring 108 may allow electronic components to be installed on each fence section 100. The wiring 108 may have a plurality of connectors 110 attached thereto. The connectors 110 may allow the wiring 108 of one fence section 100 to be attached to wiring 108 of an adjoining fence section 100. The connectors 110 may further allow the wiring 108 of one fence section 100 to be attached to different types of monitoring and or security equipment 112. The monitoring and or security equipment 112 may be cameras 22, photoelectric entrance beams 34, motion sensors 120, lights, RFID tag transmitter/receivers 131 which may be used to monitor and or take inventory of equipment having tags within the perimeter of the modular fence 10A, or the like. The listing of the above is given as an example and should not be seen in a limiting scope.

Each post 102 may have a tapered bottom edge 102B. The tapered bottom edge may allow the post to be inserted into the ground with a hammer or other object. Alternatively, a stand member 102C may be formed on a bottom section of the post 102. The stand member 102C may allow the fence section 100 to sit upright and not fall over thereby possibly removing the need to insert each post 102 into the ground.

One or more openings 116 may be formed in the post 102 and or the fence rails 104 of the fence section 100. The openings 116 may be used to allow one or more of the connectors 110 to be exposed. The openings 116 may further be used to attach one or more monitoring and or security equipment 112 to the post 102 and or the fence rails 104.

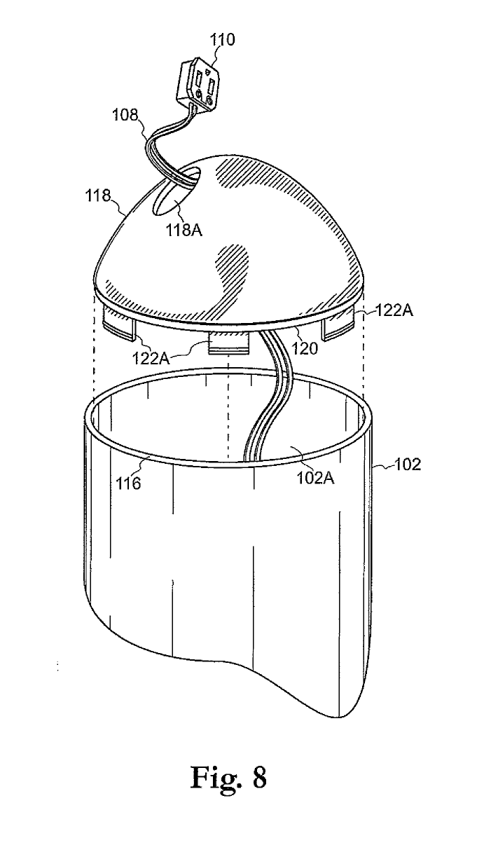

As shown in FIG. 8, in accordance with one embodiment, a top section of the post 102 remains open to form the opening 116. A cover 118 may be placed over and secured to the opening 116. The cover 118 comprises an inverted bowl portion 120 and integral depending leg portions 122A. The bowl portion 120 may come in a geometric shape to match that of the post 102. The cover 118 may further have an opening 118A. The opening 118A may be used to allow one or more of the connectors 110 to be exposed. The openings 118a may further be used to attach one or more monitoring and or security equipment 112 to the post 102.

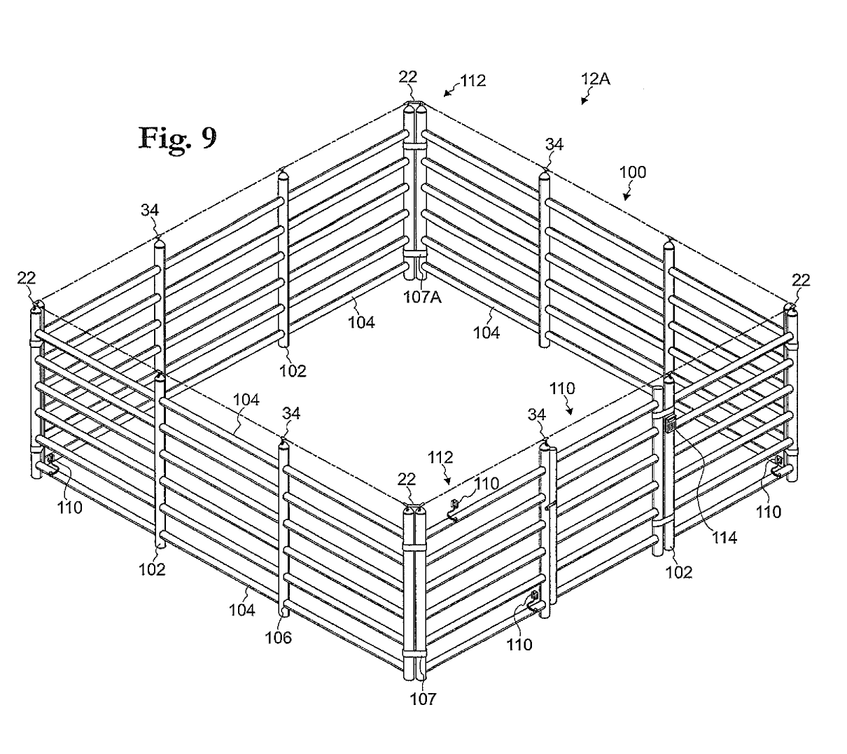

As shown more clearly in FIG. 9, a plurality of fence sections 100 maybe attached together to form an enclosure. As stated above, the enclosure may form part of the virtual guard gate for a gated community 10 as discussed above. Alternatively, enclosure may be used to enclose an area or objects (i.e. construction equipment, etc) for security. Adjacent fence sections 100 may be coupled together with connectors 107. The connectors 107 may be metal straps 107A or the like. Positioned in between one adjacent pair of fence sections 100 may be a control panel 114. The control panel 114 may be used to control the operation of the different security equipment 112 which may be attached to the modular fence 12A. The control panel 114 may contain other equipment such as but not limited to transmitter/receiver devices, power supplies, video storage devices, and the like. The circuitry of the control panel 114 will be discussed below.

As shown in FIG. 9, attached to the openings 116 and or 118A may be a plurality of monitoring cameras 22 and at least one photoelectric beam 34. The monitoring cameras 22 and at least one photoelectric beam 34 are used to prevent unauthorized individuals from climbing over the modular fence 12A. The monitoring cameras 22 may be directed upwardly as to not contain any of the structures contained within the gated community 46 so as to eliminate privacy concerns. However, it should be clear that substantial benefit could be derived from an alternative embodiment of the present invention in which the monitoring cameras 22 are differently positioned. For example, if the modular fence 12A may be used to enclose an area or objects (i.e. construction equipment, etc) for security, the monitoring cameras 22 may be directed inwardly towards the construction equipment, etc. The monitoring cameras 22 may be directed outwardly to monitor the perimeter around the modular fence 12A.

In general, a plurality of photoelectric beams 34 is used wherein the photoelectric beams 34 run in a horizontal plane on top of one another. The photoelectric beams 34 run parallel to, and on top of, the modular fence 12A, and have a sufficient distance between them to allow the passage of a small animal, such as a cat or a bird, over the modular fence 12A while breaking only one of the photoelectric beams 16. This prevents false triggering.

If multiple photoelectric beams 34 are broken, an alarm may be trigger. If multiple photoelectric beams 34 are broken a signal may be sent to the control panel 114. The control panel 114 may sound a visual and or audible alarm, may send a signal via a transmitter/receiver device to a third party monitoring station, etc. Further, if multiple photoelectric beams 34 are broken a signal may be sent to the control panel 114 which activates at least one monitoring camera 22 to capture images of the area where the photoelectric beams 34. In accordance with one embodiment, any facial images captured by the monitoring cameras 14 are transmitted to the server 37 for analysis so that the server 37 may possibly identify the unauthorized individual.

In accordance with one embodiment of the present invention, the photoelectric beams 16 originate from a single generating source 62 and are directed around the modular fence 12A using a plurality of partially transparent yet partially reflective mirrors 58 and reflective mirrors 60.

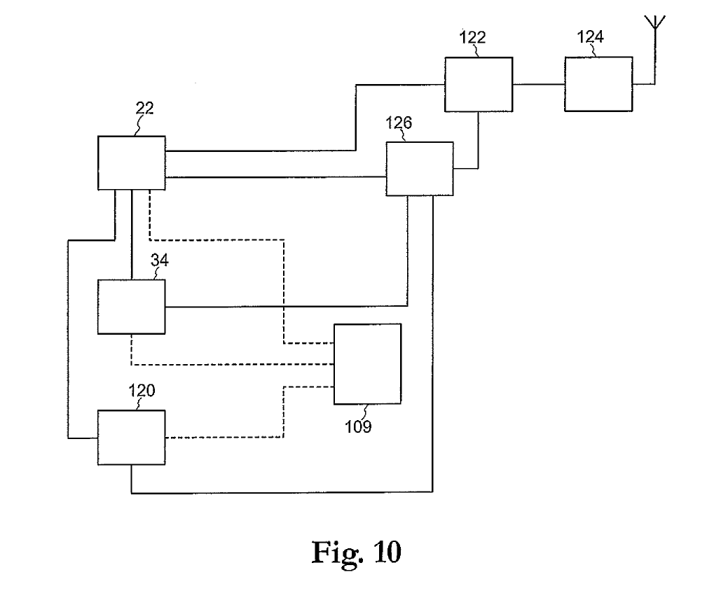

Referring now to FIG. 10, a simplified functional block diagram of the control panel 114 is shown. The control panel 114 may be attached to the different security equipment 112 which may be attached to the modular fence 12A. Thus, the control panel 114 is coupled to the different monitoring cameras 22, the photoelectric beam 34, motion or any other type of sensor 120. The different security equipment 112 may be attached to a power supply 109. Alternatively, the different security equipment 112 may be self powered. In accordance with one embodiment of the present invention, the system may have a back-up power supply 109A. Thus, if power is lost to the fence 12, a back-up power supply will provide power to the different electronic components. The sensors 120 may be active sensors or passive sensors. In accordance with one embodiment, the sensors 120 are passive sensors to conserve power.

In accordance with one embodiment, the photoelectric beam 34 and or a sensor 120 is coupled to the monitoring cameras 22. When the photoelectric beam 34 and or a sensor 120 is tripped, the control panel 114 may active one or more of the monitoring cameras 22. The monitoring cameras 22 may send data images to a recording device 122. The recording device 122 may be coupled to a transmitter/receiver device 124. The transmitter/receiver device 124 may be used to compress and transmit the data images being recorded to a device such as a cellular phone, computer, laptop, personal digital assistant, and the like. Alternatively, the transmitter/receiver device 124 may compress and transmit the video stream being recorded to a third party monitoring company.

Alternatively, the photoelectric beam 34 and or sensor 120 may be coupled to a control unit 126. The control unit 126 is then coupled to the monitoring cameras 22. The control unit 126 is used to activate and control the monitoring cameras 22. When the photoelectric beam 34 and or sensor 120 is tripped, the control unit 126 may be used to activate and control the monitoring cameras 22 closes to the location where the photoelectric beam 34 and or sensor 120 is tripped. In this embodiment, the monitoring cameras 22 may send data images to the recording device 122. The transmitter/receiver device 124 may be used to compress and transmit the data images being recorded to a device such as a cellular phone, computer, laptop, personal digital assistant, and the like. Alternatively, the transmitter/receiver device 124 will compress and transmit the video stream being recorded to a third party monitoring company. In this embodiment, the transmitter/receiver device 124 may be coupled to the control unit 126. This will allow a third party to send a signal to the transmitter/receiver device 124 which may then be sent to the control unit 126 to control a desired monitoring camera 14.

It should be noted that not just wiring 108, but the electronics themselves may be built into the fence 12, or a fence section 100. Further, the components of the control panel 114 may also be built into the fence 12, or a fence section 100. Thus, the fence 12 or a fence section 100 may itself contain computer hardware, a DVR system, video analytic software, wireless communications, and for that matter, a power source, such as lithium ion batteries, or solar. While in accordance with one embodiment, the modular fence 12A is designed so that certain electronic components may be built into a predetermined fence section 100, other electronic components may still be added to the different fence sections 100.

It should be further noted, that in accordance with one embodiment, the electronics in each fence section may be wirelessly coupled together. Thus, the fence 12 or the fence section 100 may not require the wiring 108. Instead, each electronic component wireless communicates with other electronic components and or the control panel 114. In this embodiment, the control panel 114 which may be a separate panel or built into one of the fence sections 100 may monitor the different electronic components as well as the different fence sections 100. Thus, the control panel 114 will be able to identify when a fence section 100 goes offline such as if a person and or device (i.e., car, etc.) breaks down a fence section 100. In this embodiment, each fence section 100 is like a node on a network. The control panel 114 monitors each fence section 100 like a node on a network.

While embodiments of the disclosure have been described in terms of various specific embodiments, those skilled in the art will recognize that the embodiments of the disclosure can be practiced with modifications within the spirit and scope of the claims, and will also recognize that different features of different embodiments may be combined and incorporated into other embodiments.

What is claimed is:

1. A modular fence comprising:
at least one post member having a hollow interior section;
at least one rail having a hollow interior section, wherein the rail is coupled to the post, the hollow interior section of the post member in communication with the hollow interior section of the rail;
a holding device formed on a bottom section of the post member to position the modular fence in an upright position;
a plurality of openings formed in the post member and the rail;
wiring positioned in the interior section of the post and the interior section of the rail;
connectors attached to the wiring; and
security equipment attached to the wiring via the connectors, wherein the security equipment is attached to at least one of the post member or rail through one of the plurality of openings.

2. A modular fence in accordance with claim 1 wherein security equipment comprises at least one of: sensors, cameras, lights, photoelectric beam, and the like.

3. A modular fence in accordance with claim 1 wherein the holding device is a tapered edge formed on a bottom area of the post.

4. A modular fence in accordance with claim 1 wherein the holding device is a stand.

5. A modular fence in accordance with claim 1 further comprising a pair of post members, a plurality of rails positioned between the pair of post wherein the hollow interior sections of the rails are in communication with the hollow interior section of the posts.

6. A modular fence in accordance with claim 1 further comprising a control panel attached to the wiring.

7. A modular fence comprising:
a plurality of fence sections coupled together to form an enclosure, wherein each fence section comprises:
at least one post member having a hollow interior section;
at least one rail having a hollow interior section, wherein the rail is coupled to the post, the hollow interior section of the post member in communication with the hollow interior section of the rail;
a holding device formed on a bottom section of the post member to position the modular fence in an upright position;
a plurality of openings formed in the post member and the rail;
wiring positioned in the interior section of the post and the interior section of the rail;
connectors attached to the wiring, wherein one set of connectors attached wiring from adjacent fence sections; and
security equipment attached to the wiring via a second set of connectors, wherein the security equipment is attached to at least one of the post member or rail through one of the plurality of openings.

8. A modular fence in accordance with claim 7 further comprising a control panel coupled to a adjacent fence sections to form the enclosure.

9. A modular fence in accordance with claim 7 wherein security equipment comprises at least one of: sensors, cameras, lights, photoelectric beam, and the like.

10. A modular fence in accordance with claim 1 wherein the holding device is a tapered edge formed on a bottom area of the post.

11. A modular fence in accordance with claim 1 wherein the holding device is a stand.

12. A modular fence in accordance with claim 1 further comprising a pair of post members, a plurality of rails positioned between the pair of post wherein the hollow interior sections of the rails are in communication with the hollow interior section of the posts.

13. A modular fence in accordance with claim 1 further comprising a control panel attached to the wiring.

14. A modular fence comprising:
at least one post member;
at least one rail, wherein the rail is coupled to the post;
a holding device formed on a bottom section of the post member to position the modular fence in an upright position;
a plurality of openings formed in the post member and the rail; and
security equipment attached to the at least one of the post member or rail through one of the plurality of openings.

15. A modular fence in accordance with claim 14 wherein security equipment comprises at least one of: sensors, cameras, lights, photoelectric beam, RFID transmitter/receiver and the like.

16. A modular fence in accordance with claim 14 wherein the holding device is a tapered edge formed on a bottom area of the post.

17. A modular fence in accordance with claim 14 wherein the holding device is a stand.

18. A modular fence in accordance with claim 14 wherein the at least one post member has a hollow interior section and the at least one rail has a hollow interior section, wherein the rail is coupled to the post, the hollow interior section of the post member in communication with the hollow interior section of the rail and wiring positioned in the interior section of the post and the interior section of the rail.

19. A modular fence in accordance with claim 14 further comprising connectors attached to the wiring, the security equipment attached to the wiring via the connectors.

20. A modular fence in accordance with claim 14 further comprising a control panel coupled to monitor the security equipment.

21. A modular fence in accordance with claim 20 further comprising a control panel coupled to monitor the security equipment.

22. A modular fence in accordance with claim 21 wherein the control panel monitors the modular fence, wherein each section of the modular fence represents a node on network.
